(19) United States
(12) Patent Application Publication
(10) Pub. No.: US 2026/0117554 A1
(43) Pub. Date: Apr. 30, 2026

(54) LIGATURE RESISTANT DOOR LOCK INTERFACE

(71) Applicant: Securitech Group, Inc., Maspeth, NY (US)

(72) Inventors: Mark J. Berger, New York, NY (US); David Mate, Maspeth, NY (US)

(73) Assignee: Securitech Group, Inc., Maspeth, NY (US)

(21) Appl. No.: 19/279,593

(22) Filed: Jul. 24, 2025

Related U.S. Application Data
(60) Provisional application No. 63/712,073, filed on Oct. 25, 2024.

(51) Int. Cl. E05B 13/10; E05B 65/00

(52) U.S. Cl. CPC E05B 13/105; E05B 65/00

(57) ABSTRACT

A ligature resistant door lock interface is disclosed herein. In some embodiments the interface may include a pushbutton configured to lock an associated door lock. In some embodiments, the door lock may be a mortise lock. The interface may have sloped exterior surfaces and have a relatively large diameter. In some embodiments, the interface may be overridden, which allows an operator to unlock the door from an exterior side, regardless of whether the pushbutton is held in a depressed position.

### CROSS-REFERENCE TO RELATED

This application claims the benefit under 35 U.S.C. § 119(e) to U.S. Provisional Application Ser. No. 63/712,073, entitled “LIGATURE RESISTANT DOOR LOCK INTERFACE,” filed Oct. 25, 2024, which is incorporated herein by reference.

### FIELD

Disclosed embodiments are related to a ligature resistant door lock interface.

### BACKGROUND

In environments where people pose a threat to themselves, ligature resistant handle assemblies have been used to ensure that patients cannot use them as an anchor point of a noose. Nurses or other caretakers may want to have access in case of emergency to a room that is locked with a patient inside. This remains true even if the patient is actively trying to lock the door and prevent a nurse or caretaker from gaining access to the room.

Ligature resistant door handle assemblies are designed to have no surface which slopes towards the escutcheon. In other words, the distal portion of the top surface of the handle must remain lower than the proximal portion of the handle, and the distal portion of the bottom surface must remail higher than the proximal portion of the handle. This is designed such that a rope or cord cannot be hung from the door handle, and if this is attempted, the rope or cord would simply slide off. Additionally, some ligature resistant door handle assemblies exist where a portion of a movable handle extends in a generally parallel construction, but when a force is applied to the handle, the handle pivots, and a noose would slide off.

Additionally, friction may influence a ligature resistant handle's effectiveness. For example, if the coefficient of friction is too high, when a force is applied to the rope or cord, the frictional force may be too high on the sloped handle surface, causing the cord to remain on the door handle and rendering the ligature resistant geometry ineffective. Thus, even though the geometry of the handle assembly may be appropriate for an anti-ligature device, it may not function as intended.

### SUMMARY

In some embodiments the device described herein relates to a ligature resistant door lock interface comprising an escutcheon having a proximal end configured to lie closest to a door when mounted thereto and a distal end opposite the proximal end and a pushbutton at least partially disposed within the escutcheon. The pushbutton having a distal tip, wherein the pushbutton is configured to lock a corresponding door lock when the pushbutton is depressed, wherein the door lock interface has dimensions comprising, a height of the escutcheon between the proximal end and distal end of approximately 0.6 inches, a pushbutton protruding distance defined as the distance between the distal end of the escutcheon and the distal tip of the pushbutton, the pushbutton protruding distance being approximately 0.3 inches when the pushbutton is in an extended configuration, a diameter of the pushbutton at the distal end of the escutcheon being approximately 1.25 inches when the pushbutton is in the extended configuration, and a diameter of the escutcheon at the proximal end of the escutcheon being approximately 2.1 inches.

In some embodiments the device described herein relates to a ligature resistant door lock interface comprising a pushbutton rotationally fixed relative to an escutcheon and configured to be disposed on an interior side of a door, wherein the pushbutton is configured to lock a corresponding door lock when the pushbutton is moved to a depressed configuration, and a door lock override configured to allow unlocking of the door lock from an exterior side despite the pushbutton remaining in the depressed configuration.

In some embodiments the device described herein relates to a mortise lock comprising, a lock body, a ligature resistant door lock interface coupled to the lock body, the interface comprising, an escutcheon having a proximal end configured to lie closest to a door when mounted thereto and a distal end opposite the proximal end, a pushbutton at least partially disposed within the escutcheon, a cam connected to the pushbutton configured to be depressed and convert linear movement of the pushbutton into rotation movement of a locking actuator, and wherein the mortise lock is configured to be locked and unlocked by at least partial rotation of the locking actuator caused by depressing the pushbutton.

It should be appreciated that the foregoing concepts, and additional concepts discussed below, may be arranged in any suitable combination, as the present disclosure is not limited in this respect. Further, other advantages and novel features of the present disclosure will become apparent from the following detailed description of various non-limiting embodiments when considered in conjunction with the accompanying figures.

### BRIEF DESCRIPTION OF DRAWINGS

In the drawings, each identical or nearly identical component that is illustrated in various figures is represented by a like reference character. For purposes of clarity, not every component may be labeled in every drawing. The drawings are not necessarily drawn to scale, with emphasis instead being placed on illustrating various aspects of the techniques and devices described herein. In the drawings:

FIG. 1 depicts a door handle assembly on a door showing a ligature resistant door lock interface;

FIG. 2 depicts a front perspective view of the ligature resistant door lock interface shown in FIG. 1;

FIGS. 3A-3B depict front perspective views of the ligature resistant door lock interface in the extended and depressed configurations, respectively;

FIG. 4A depicts a rear perspective view of a portion of the door lock interface;

FIG. 4B depicts a rear perspective view of an escutcheon portion of the door lock interface;

FIGS. 5A-5B depict rear perspective views of the ligature resistant door lock interface in extended and depressed configurations, respectively;

FIGS. 6A-6B depict section views of the ligature resistant door lock interface with a clutch disengaged and engaged, respectively; and

FIG. 7 depicts a rear, top perspective of the ligature resistant door lock interface.

### DETAILED DESCRIPTION

The inventors have recognized that, in environments where a ligature resistant door handle assembly is needed, additional door handle attributes may further improve the safety and operability for the user. The inventors have created a portion of a ligature resistant door handle assembly which incorporates mechanisms and structures that increase the safety level of a patient who is using the door handle.

As used herein, an interior side may refer to the side of the door which has access to a ligature resistant door lock interface button.

As used herein, an exterior side may refer to the side of the door which does not have access to the ligature resistant door lock interface button.

As used herein, the proximal side of the ligature resistant door lock interface is the side which is closer to a door.

As used herein, the distal side of the ligature resistant door lock interface is the side further from the door and is opposite the proximal side.

As used herein, a depressed configuration is when the pushbutton is positioned in its most proximal location.

As used herein, an extended configuration is when the pushbutton is positioned in its most distal location.

The inventors have created a door lock interface suitable for use in hospitals or environments where people may pose a risk to themselves. The inventors have created a door lock interface which in some embodiments may be easy to actuate, locks a mortise lock from the interior side of the door, and may be overridden from an exterior side of the door. That is, to lock the mortise lock, the user simply pushes on the pushbutton. Further, the interface may be constructed with a generally tapered structure in order to reduce the feasibility of the interface acting as a ligature mounting point.

The inventors have recognized that a conventional push button may be difficult to actuate for users with fine motor skill deficiencies, or any ailment which reduces one's ability to precisely interact with a conventional actuator. This may include people who have optical deficiencies, amelia, or are an amputee. Accordingly, the inventors have created an interface with a large pushbutton diameter. The large diameter of the pushbutton and overall interface may assist a user in both identifying and actuating the interface. The inventors have recognized that the pushbutton along with the interface as a whole may be marked with various colors to further improve the visibility of the interface.

The inventors have also recognized the simplicity in actuating a large pushbutton based door lock interface, and its value in the environments enumerated above. In one embodiment, the pushbutton is configured to cooperate with a lock, such as a mortise lock. To actuate the interface and lock the mortise lock, a user may depress the pushbutton, as will be discussed further below with reference to the figures.

The inventors have recognized that it may be beneficial for the mortise lock to be unlockable from an exterior side. Further, the inventors have appreciated the value in being able to unlock the mortise lock despite the pushbutton being in a depressed configuration. For example, a patient who poses a risk to themselves may enter a room and hold the pushbutton in a depressed configuration. In order to enter the room and ensure that the patient does not hurt themselves, the door lock must be capable of being unlocked from the exterior side and thus override the depressed pushbutton. Accordingly, the inventors have created a clutch like system which allows the door lock to be locked and unlocked independently of the pushbutton status (i.e., whether the pushbutton is depressed or not) from the exterior side of the door. In some embodiments, the clutch like system may be considered an override. The override may also be any other configurable linkage which permits and restricts movement of a locking actuator relative to the pushbutton.

The inventors have recognized that it may be beneficial for the interface to have generally tapered structure which prevents the interface from being used as an anchor point for a ligature. Accordingly, the inventors have created the interface such that the diameter of the interface is smaller on the distal end than the proximal end. In some embodiments the interface may continuously taper such that diameter of any first point is smaller than the diameter of any second point located proximally relative to the first point. The interface may be constructed of stainless steel, or any other material with a sufficiently low coefficient of friction such that the interface cannot be used as an anchor point for a ligature. The threshold for the aforementioned coefficient of friction may vary depending on the slope of the taper. For example, if the taper is more aggressive, a material with a generally higher coefficient of friction may still be used without a ligature sticking to the surface of the interface. On the other hand, if the taper is more gradual, a material with a generally lower coefficient of friction may be beneficial to prevent a ligature from sticking to the surface of the interface.

Turning to the figures, specific non-limiting embodiments are described in further detail. It should be understood that the various systems, components, features, and methods described relative to these embodiments may be used either individually and/or in any desired combination as the disclosure is not limited to only the specific embodiments described herein.

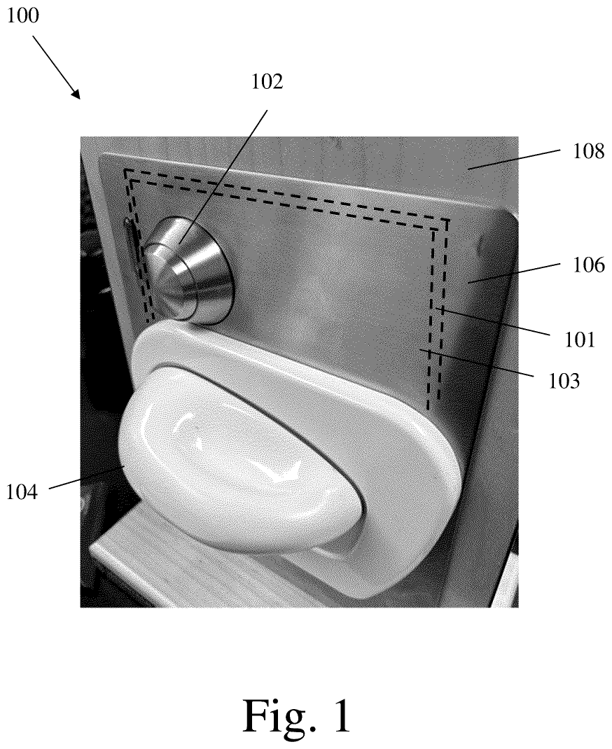

FIG. 1 shows a ligature resistant door handle assembly including a ligature resistant door lock interface on a door. In some embodiments the interface 102 may be disposed on a baseplate 106. The baseplate 106 may be disposed on the door 108. In other embodiments, the interface 102 may be disposed adjacent the door 108. In these embodiments, the baseplate 106 may not be present. The above-mentioned features are depicted on an interior side of the door. In some embodiments, the door handle assembly 100 may be constructed on a door in a mental hospital, or other location where people pose a threat to themselves. For example, the door handle assembly 100 may be constructed on an interior side of a bathroom door, where a patient may be alone. Accordingly, the inventors have recognized the value in constructing the interface 102 such that it cannot be used as an anchor point for a ligature. In some embodiments, the corresponding door handle 104 may be a ligature resistant door handle. The inventors have recognized that pairing the ligature resistant interface 102 with a ligature resistant door handle 104 may increase the safety of the door handle assembly 100. The specific dimensions which improve the interface's ligature resistant properties will be discussed below.

FIG. 1 also illustrates the relative size of the interface 102. When compared to the door handle 104, the atypical size of the interface 102 can clearly be seen.

FIG. 1 also illustrates the placement of a mortise lock 101 which may be disposed within the door 108. The mortise lock may include a mortise lock body 103 which may house various components traditionally associated with mortise locks.

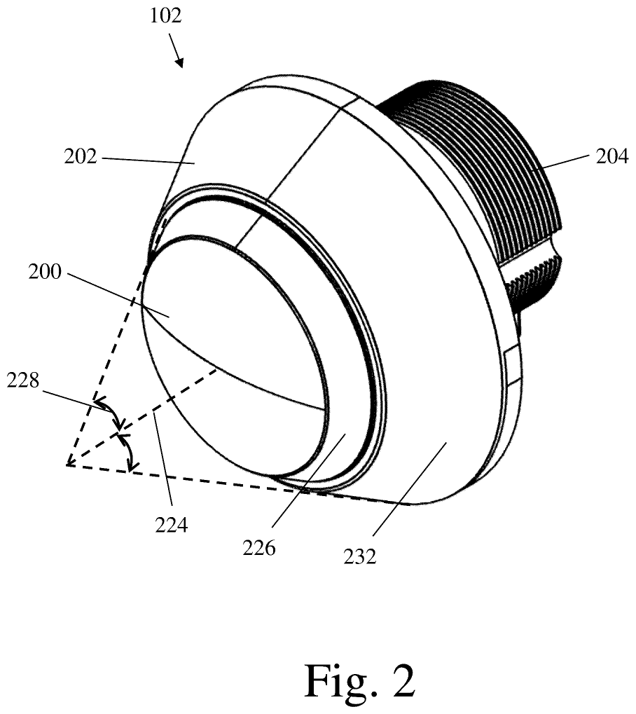

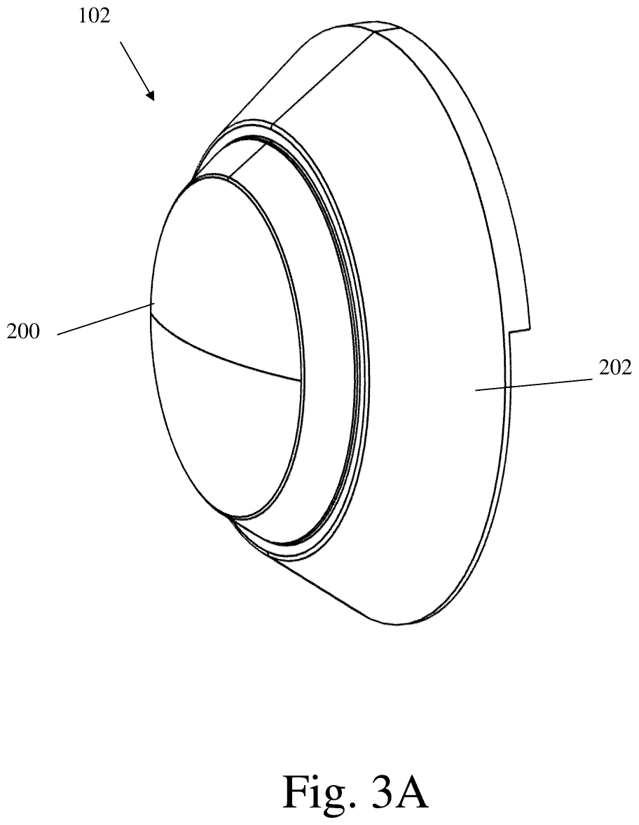

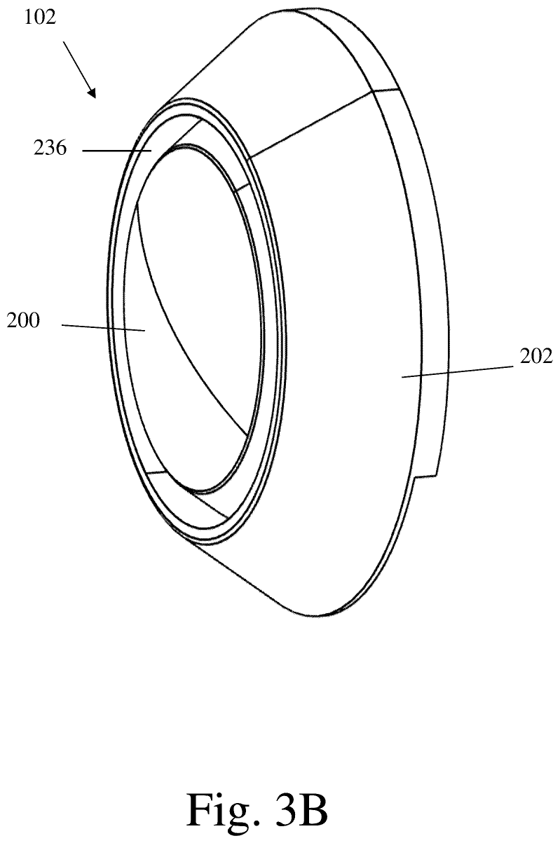

FIG. 2 depicts the ligature resistant door lock interface. In some embodiments, the interface may comprise a pushbutton 200, an escutcheon 202 and a threaded base 204. In some embodiments, the pushbutton 200 may be depressed in order to actuate the interface 102. In some embodiments, actuating the interface 102 results in locking an associated door lock. In some embodiments, the door lock may be a mortise lock. The pushbutton 200 may exist in at least an extended configuration and a depressed configuration (seen in FIGS. 3A and 3B respectively).

The diameter of the pushbutton 200 is measured from a proximal side of the exposed pushbutton when the pushbutton is in the extended configuration. In other words, the diameter of the pushbutton 200 is measured from the distal end of the escutcheon 202 when the pushbutton 200 is in the extended configuration. In some embodiments, the pushbutton 200 may have a diameter between 1 inch and 1.5 inches. In some embodiments, the pushbutton 200 may have a diameter between 1.2 inches and 1.3 inches. In some embodiments, the pushbutton 200 may have a diameter of approximately 1.25 inches.

In some embodiments, the pushbutton 200 may protrude from the escutcheon 202 when in the extended configuration. In some embodiments, the pushbutton may protrude between 0.2 inches and 0.4 inches. In some embodiments, the pushbutton may protrude approximately 0.3 inches. In some embodiments, the pushbutton protruding distance may be defined as the distance between the distal end of the escutcheon 202 and the distil tip of the pushbutton 200.

In some embodiments, the pushbutton 200 may taper from the portion adjacent to the distal end of the escutcheon 202, when the pushbutton is in the extended position, to the distal end of the pushbutton 200. In some embodiments, the pushbutton taper angle 228, which may be defined as the angle between a line 224 running parallel to the length of the pushbutton (e.g., along a central axis) and the exterior surface 226 of the pushbutton, may be between 10° and 50°. In some embodiments, the pushbutton taper angle may be between 20° and 40°. In some embodiments, the pushbutton taper angle may be approximately 30°. In some embodiments, the pushbutton taper angle may prevent a user from anchoring a ligature on the exterior surface 226 of the pushbutton 200.

In some embodiments, the pushbutton 200 may extend through a center of the escutcheon 202. In some embodiments, the escutcheon 202 may be rotationally fixed to the pushbutton 200. In other words, the pushbutton 200 may not be able to rotate without the escutcheon 202 rotating. In some embodiments, the escutcheon may be fixed to a door 108 or a baseplate 106. The proximal end of the escutcheon may be configured to lie closest to a door when mounted thereto. Accordingly, in those embodiments, the pushbutton may not be able to rotate. In some embodiments, the pushbutton 200 may be able to linearly move relative to the escutcheon 202.

A height of the escutcheon 202 may be measured as the distance between the proximal and distal end of the escutcheon. In some embodiments, the escutcheon 202 may have a height between 0.3 inches and 0.9 inches. In some embodiments, the escutcheon 202 may have a height between 0.5 inches and 0.7 inches. In some embodiments, the escutcheon 202 may have a height of approximately 0.6 inches. The relatively large height of the escutcheon may increase the visibility of the interface and increase accessibility.

In some embodiments, the escutcheon 202 may have a diameter between 1.5 inches and 2.7 inches. In some embodiments, the escutcheon 202 may have a diameter between 1.9 inches and 2.3 inches. In some embodiments, the escutcheon 202 may have a diameter of approximately 2.1 inches. The diameter of the escutcheon 202, as discussed above, is measured from a proximal side of the escutcheon. This diameter may be the largest diameter of the interface 102. This larger diameter for a portion of the interface 102 may assist a user in identifying the interface 102 and increase the accessibility of the door handle assembly 100.

In some embodiments, the escutcheon 202 may taper from the proximal end to the distal end. In some embodiments, the escutcheon taper angle 230, which may be defined as the angle between a line 224 running parallel to the length of the pushbutton (e.g., along a central axis) and the exterior surface 232 of the escutcheon, may be between 10° and 50°. In some embodiments, the escutcheon taper angel may be between 20° and 40°. In some embodiments, the escutcheon taper angle may be approximately 30°. In some embodiments, the escutcheon taper angle may prevent a user from anchoring a ligature on the exterior surface 232 of the escutcheon. Accordingly, in some embodiments, both the exterior surface 226 of the escutcheon and the exterior surface 232 of the pushbutton may not be able to support a ligature. Therefore, the interface as a whole may be considered a ligature resistant device as all exterior surfaces may not be able to support a ligature.

In some embodiments, the threaded base 204 connects the interface 102 to the door 108 or baseplate 106. The height of the threaded base 204 may correspond to the distance the threaded base may extend into a door 108. In some embodiments, the threaded base 204 may extend into the door 108 between 0.5 inches and 1 inch. In some embodiments, the threaded base 204 may extend into the door 108 between 0.7 inches and 0.8 inches. In some embodiments, the threaded base 204 may extend into the door 108 approximately 0.75 inches. In some embodiments, the diameter of the threaded base 204 may be between 0.7 inches and 1.6 inches. In some embodiments, the diameter of the threaded base 204 may be between 1 inch and 1.3 inches. In some embodiments, the diameter of the threaded base 204 may be approximately 1.15 inches. The length and/or diameter of the threaded base 204 may increase the strength of the connection between the interface 102 and the door 108.

FIGS. 3A-3B depict front perspective views of the ligature resistant door lock interface in the extended and depressed configurations. When in the depressed configuration, the pushbutton 200 is in its most proximal state. In some embodiments, the pushbutton 200 may be configured to retract completely within the escutcheon 202. In other embodiments, the pushbutton 200 may only be configured to partially retract within the escutcheon 202. The inner surface 236 of the escutcheon 202 may be colored such that when exposed by the pushbutton 200 being disposed in the depressed configuration, a user may easily identify the configuration.

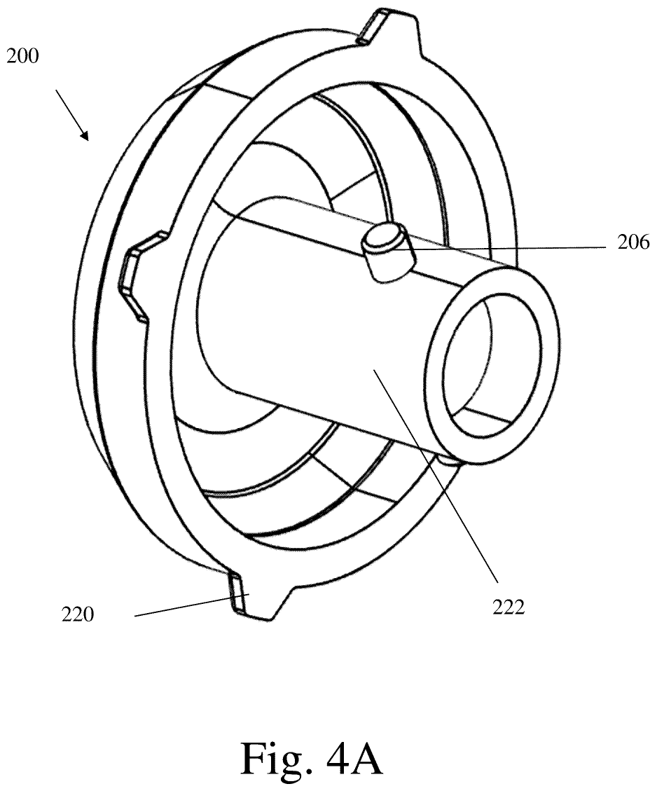

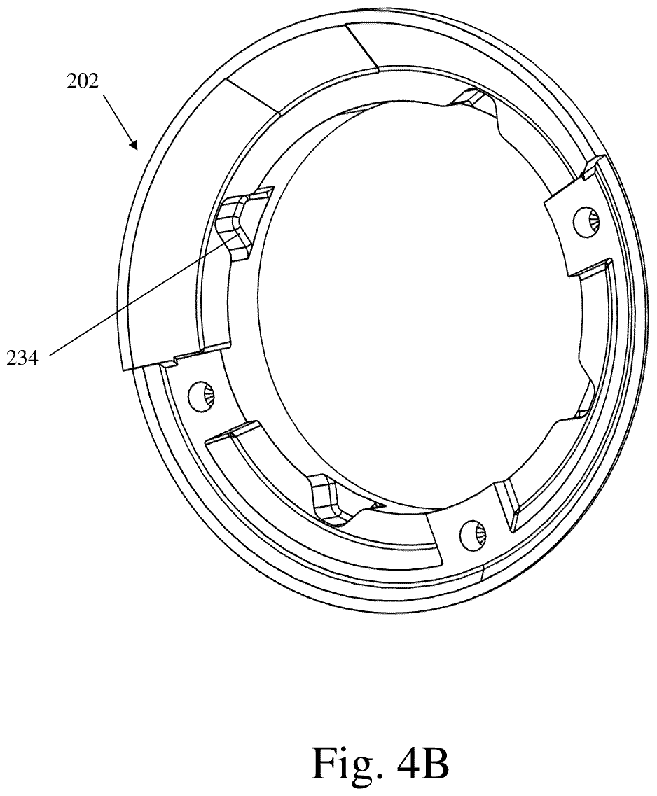

FIG. 4A depicts a rear perspective view of the pushbutton 200. FIG. 4B depicts a rear perspective view of the escutcheon 202. From this perspective seen in FIG. 4A, pins 206 and pushbutton anchoring tabs 220 are depicted. The pins 206 are positioned on the central shaft 222 which is a portion of the pushbutton 200. The pushbutton anchoring tabs 220 are positioned at the side of the pushbutton 200. The pushbutton anchoring tabs 220 are configured to be received by the anchoring tab receptacles 234. In some embodiments, the pushbutton anchoring tabs 220 are configured to linearly slide within the anchoring tab receptacles 234. This motion may permit linear movement of the pushbutton 200 relative to the escutcheon 202. However, in some embodiments, the pushbutton anchoring tabs 220 are configured to be rotationally fixed within the anchoring tab receptacles 234. Therefore, in some embodiments, the pushbutton 200 may not rotate independently of the escutcheon 202.

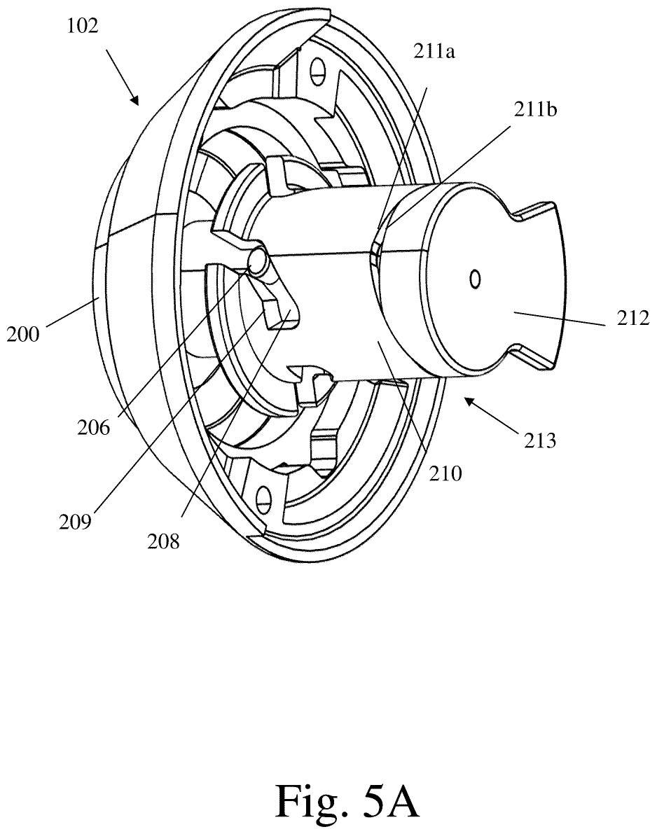

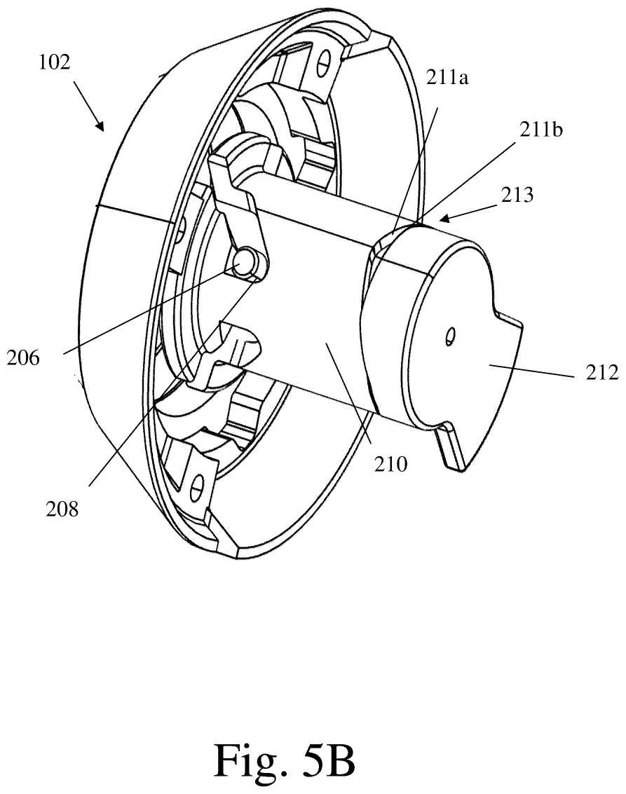

FIGS. 5A-5B depict rear perspective views of the ligature resistant door lock interface in extended and depressed configurations, respectively. From this perspective, the pushbutton 200, pin 206, guide 208, cylindrical shell 210, and locking actuator 212 can be seen. In some embodiments, these components convert the linear motion of the pushbutton 200 into rotation motion which locks a corresponding mortise lock. Accordingly, in some embodiments, the cylindrical shell 210 may be considered a cam. In some embodiments the mortise lock may be locked by partial rotation of the locking actuator 212. Accordingly, in some embodiments discussed below, internal components of the interface 102 are configured to translate linear movement of the pushbutton 200 into rotational movement of the locking actuator 212.

As will be appreciated, the mortice lock is actuated by rotation of a lock shaft. In order to cause the mortice lock to lock, a user may depress the pushbutton 200, transferring the pushbutton 200 from the extended configuration to the depressed configuration. This linear motion of the pushbutton translates into rotational movement of the locking actuator 212 so that the mortice lock can be locked. As noted above, the pushbutton has a central shaft 222 with at least one pin 206 disposed on a surface of the central shaft 222. When the pushbutton 200 is depressed, the pin moves proximally. The pin may be disposed in a guide 208 with the cylindrical shell at least partially surrounding or partially circumscribing the central shaft 222. As can be seen in FIG. 5A, in some embodiments, the guide 208 includes a ramped surface. Therefore, in some embodiments, when the pin moves proximally, it contacts the guide 208 which causes the cylindrical shell 210 to rotate. The rotation of the cylindrical shell 210 may then cause the locking actuator 212 to rotate. The cylindrical shell 210 and locking actuator 212 may have complementarily shaped adjacent surfaces, which, when contacting each other, allow the rotational movement of the cylindrical shell 210 to transfer to the locking actuator 212 also causing the locking actuator 212 to rotate. These surfaces 211a, 211b may be non-flat which may allow the cylindrical shell 210 and the locking actuator 212 to at least partially mate when contacting each other, as can be seen in FIGS. 5A-5B. Therefore, when the shell 210 rotates, the rotational force at the non-flat surface 211a of the cylindrical shell pushes on the non-flat surface 211b of the locking actuator 212, causing it to rotate.

As mentioned above, FIG. 5B depicts one embodiment of the interface 102 with the pushbutton 200 in the depressed configuration. Accordingly, the pin 206 is seen in the proximal portion of the guide 208. Further, the locking actuator 212 has been partially rotated clockwise. This rotation may be sufficient to lock a corresponding mortise lock. In some embodiments, in order to unlock the mortise lock from the interior side, a user may actuate a corresponding door handle 104.

In some embodiments, when the mortise lock is being unlocked from the exterior side, rotational movement of the locking actuator 212 may transfer to the cylindrical shell 210, causing the shell 210 to also rotate. This rotational movement of the shell causes the guide 208 to push the pin 206 to a distal location which would return the pushbutton 200 into the extended configuration.

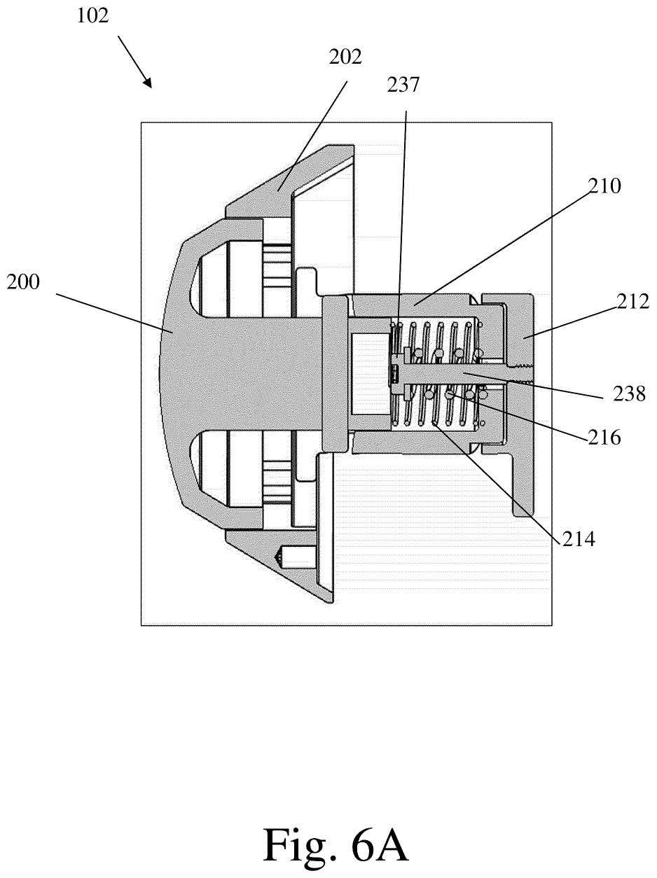

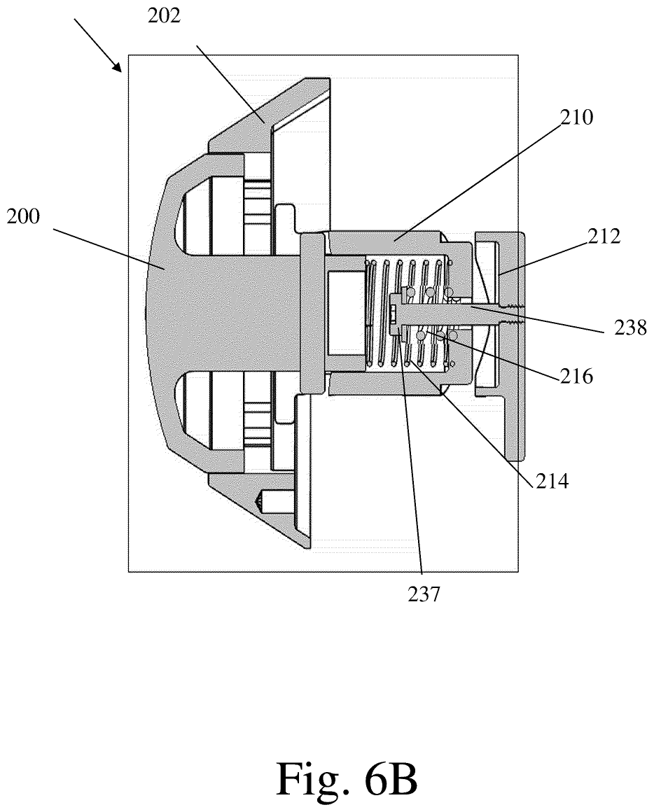

As noted above, and as will be discussed in more detail below with respect to FIGS. 6A-6B, should a user on the interior side of the door maintain depressing pressure on the pushbutton 200 (i.e., maintaining the pushbutton in the depressed state), the linear movement of the pin 206 would be restricted, and thus the cylindrical shell 210 would not be able to rotate. The user on the interior side may therefore prevent an operator on the exterior side from unlocking the door. Accordingly, in one embodiment, the interface surfaces 211a, 211b act as at least a portion of a clutch 213 that allows the locking actuator 212 to rotate. In this respect, the locking actuator 212 is able to separate from the cylindrical shell 210. With the locking actuator 212 separated from the cylindrical shell 210, the locking actuator 212 may rotate independently of the cylindrical shell 210. Accordingly, even if a user is applying force sufficient to retain the pushbutton 200 in the depressed configuration, an operator on the exterior side of the door may still unlock the mortise lock by causing rotation of the locking actuator 212. In some embodiments, this feature may assist a hospital or mental health facility in ensuring access to patients who may have locked themselves in a room. This may be valuable when patients pose a potential threat to their own safety. The selective coupling and uncoupling of the locking actuator 212 and the cylindrical shell 210 will now be discussed with respect to FIGS. 6A-6B.

FIGS. 6A-6B depict cross-section views of the ligature resistant door lock interface with the clutch 213 engaged and disengaged respectively. When the clutch is engaged, the locking actuator 212 and the and the cylindrical shell 210 are held against each other by a clutch spring 216. The clutch spring 216 pushes against the cylindrical shell 210 and a cap 237 of a clutch rod 238 which is connected to the locking actuator 212. As mentioned above, the cylindrical shell 210 and locking actuator 212 may have complementarily shaped adjacent surfaces, which, when contacting each other, allow the rotational movement of the cylindrical shell 210 to transfer to the locking actuator 212. When there is sufficient rotational force applied to the locking actuator 212, the clutch disengages such that locking actuator 212 can retract (i.e., moved away from the cylindrical shell 210). This movement compresses the clutch spring 216, which retracts the clutch rod 238 and allows the surfaces 211a, 211b to slip past each other, depicted in FIG. 6B, allowing relative rotation. The locking actuator may be actuated via a key, tool, lever, or any instrument capable of allowing the actuator 212. The clutch allows therefore allows rotation of the locking actuator even when the pushbutton is held in the depressed state.

FIGS. 6A-6B also depict a pushbutton spring 214. In some embodiments, the pushbutton spring 214 biases the pushbutton towards the extended configuration. Accordingly, in order to avoid inadvertent extension of the pushbutton, in some embodiments, the guide 208 (see FIGS. 5A and 5B, includes a flat portion 209 distal to the pin 206 when the pushbutton is in the depressed configuration. In some embodiments, the flat portion 209 of the guide 208 retains the pin in the proximal position until the cylindrical shell 210 rotates.

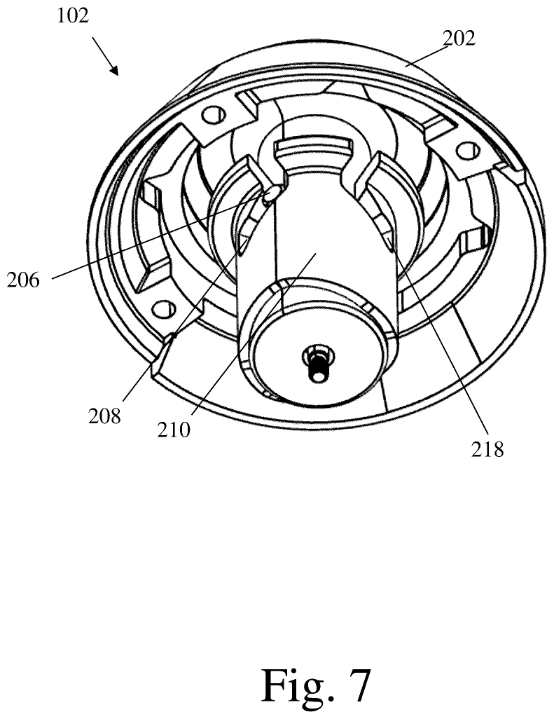

FIG. 7 depicts a rear, top perspective of the ligature resistant door lock interface. From this perspective, the pin 206 and the guide 208 are depicted. Additionally, an alternate guide 218, is depicted. In some embodiments, the guide 208 and the alternate guide 218 may have mirrored geometries. In other words, the alternate guide 218 is sloped in the opposite direction. Therefore, if the pin 206 is placed in the alternate guide 218, the cylindrical shell 210 and locking actuator 212 will rotate counterclockwise as the pushbutton 200 is depressed. As mentioned above, if the pin 206 is placed in the guide 208, the cylindrical shell 210 and locking actuator 212 will rotate clockwise as the pushbutton 200 is depressed. The inventors have recognized that a system with configurable rotating directionality enables desired handing of the lock.

While the present teachings have been described in conjunction with various embodiments and examples, it is not intended that the present teachings be limited to such embodiments or examples. On the contrary, the present teachings encompass various alternatives, modifications, and equivalents, as will be appreciated by those of skill in the art. Accordingly, the foregoing description and drawings are by way of example only.

What is claimed is:

1. A ligature resistant door lock interface comprising:
an escutcheon having a proximal end configured to lie closest to a door when mounted thereto and a distal end opposite the proximal end; and
a pushbutton at least partially disposed within the escutcheon, the pushbutton having a distal tip, wherein the pushbutton is configured to lock a corresponding door lock when the pushbutton is depressed, wherein the door lock interface has dimensions comprising:
a height of the escutcheon between the proximal end and distal end of approximately 0.6 inches;
a pushbutton protruding distance defined as the distance between the distal end of the escutcheon and the distal tip of the pushbutton, the pushbutton protruding distance being approximately 0.3 inches when the pushbutton is in an extended configuration;
a diameter of the pushbutton at the distal end of the escutcheon being approximately 1.25 inches when the pushbutton is in the extended configuration; and
a diameter of the escutcheon at the proximal end of the escutcheon being approximately 2.1 inches.

2. The interface of claim 1, in combination with the door lock, wherein the door lock is a mortise lock.

3. The interface of claim 1, wherein the pushbutton extends through a center of the escutcheon.

4. The interface of claim 1, wherein the distal tip of the pushbutton extends past the escutcheon when the pushbutton is in a depressed configuration.

5. The interface of claim 1, wherein the escutcheon is tapered from the proximal end of the escutcheon to the distal end of the escutcheon.

6. The interface of claim 1, wherein the pushbutton is tapered from the distal end of the escutcheon to the distal end of the pushbutton.

7. A ligature resistant door lock interface comprising:
a pushbutton rotationally fixed relative to an escutcheon and configured to be disposed on an interior side of a door, wherein the pushbutton is configured to lock a corresponding door lock when the pushbutton is moved to a depressed configuration; and
a door lock override configured to allow unlocking of the door lock from an exterior side despite the pushbutton remaining in the depressed configuration.

8. The interface of claim 7, further comprising a cam configured to transfers linear movement of the pushbutton to rotation movement of a locking actuator, with the locking actuator configured to lock the door lock.

9. The interface of claim 8, further comprising a cylindrical shell surrounding a shaft of the pushbutton, wherein the cam is defined by a portion of the cylindrical shell.

10. The interface of claim 9, wherein the cylindrical shell has a distal end and a proximal end, wherein the proximal end lies closest to a door when the interface is mounted to the door and wherein the proximal end has a non-flat surface.

11. The interface of claim 10, wherein the locking actuator has a complementary non-flat surface configured to mate with the non-flat surface of the cylindrical shell.

12. The interface of claim 9, wherein the door lock override is configured to allow the locking actuator to rotate without causing the cylindrical shell to rotate.

13. The interface of claim 9, wherein the door lock override is a clutch.

14. The interface of claim 13, wherein the clutch comprises a spring that biases the locking actuator towards the cylindrical shell.

15. The interface of claim 14, wherein the spring is configured to be compressed and separate the locking actuator from the cylindrical shell.

16. The interface of claim 7, in combination with the door lock, wherein the door lock is a mortise lock.

17. A mortise lock comprising:
a lock body;
a ligature resistant door lock interface coupled to the lock body, the interface comprising:
an escutcheon having a proximal end configured to lie closest to a door when mounted thereto and a distal end opposite the proximal end;
a pushbutton at least partially disposed within the escutcheon;
a cam connected to the pushbutton configured to be depressed and convert linear movement of the pushbutton into rotation movement of a locking actuator; and
wherein the mortise lock is configured to be locked and unlocked by at least partial rotation of the locking actuator caused by depressing the pushbutton.

18. The lock of claim 17, wherein the interface further comprises a cylindrical shell surrounding a shaft of the pushbutton, wherein the cam is defined by a portion of the cylindrical shell.

19. The lock of claim 18, wherein the interface further comprises a pin disposed on a central shaft of the pushbutton.

20. The lock of claim 19, wherein the interface further comprises a guide disposed on the cylindrical shell wherein the guide is configured to translate linear movement of the pin into rotation movement of the cylindrical shell.

21. The lock of claim 20, wherein the cylindrical shell has a distal and proximal end, wherein the proximal end lies closest to a door when mounted thereto and wherein the proximal end has a non-flat surface.

22. The lock of claim 21, wherein the locking actuator has a complementary non-flat surface which is configured to mate with the non-flat surface of the cylindrical shell.

23. The lock of claim 22, wherein the interface further comprises a door lock override configured to allow the mortise lock to unlock without rotating the cylindrical shell.

24. The lock of claim 23, wherein the door lock override is a clutch.

25. The lock of claim 24, wherein the clutch comprises a spring that biases the locking actuator towards the cylindrical shell.

26. The lock of claim 25, wherein the spring is configured to be compressed and separate the locking actuator from the cylindrical shell.
